(19) United States
(12) Patent Application Publication
(10) Pub. No.: US 2007/0189783 A1
(43) Pub. Date: Aug. 16, 2007

(54) IMAGE FORMING APPARATUS AND IMAGE FORMING SYSTEM

(75) Inventor: Hiroshi HATTORI, Gifu-ken (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/673,234

(22) Filed: Feb. 9, 2007

(30) Foreign Application Priority Data
Feb. 10, 2006 (JP) 2006-034273

(51) Int. Cl. G03G 15/00

(52) U.S. Cl. 399/16

(57) ABSTRACT

An image forming apparatus includes a plurality of sheet feed units, a first output unit which performs a first output prior to an image forming by an image forming unit when it is judged that no sheet feed unit accommodates a recording sheet of a requested sheet size while it is judged that a recording sheet is present in at least one of the sheet feed units, and a second output unit which performs second a output after the image forming is started when is the sheet size judging unit judges that a recording sheet judged by the sheet presence detecting units to be present in at least one of the sheet feed units does not match a recording sheet of the requested sheet size.

### CROSS-REFERENCE TO RELATED APPLICATION

This application claims priority from Japanese Patent Application No. 2006-034273, filed on Feb. 10, 2006, the entire subject matter of which is incorporated herein by reference.

### TECHNICAL FIELD

Aspects of the present invention relate to an image forming apparatus and an image forming system which feed a recording sheet to be accommodated in a sheet feed unit to an image forming unit and forms an image on the recording sheet.

### BACKGROUND

There has been proposed an image forming apparatus which feeds a recording sheet to be accommodated in a sheet feed tray to an image forming unit and forms an image on the recording sheet. For example, an image forming apparatus disclosed in JP-A-2004-338189 has a plurality of sheet cassettes for accommodating recording sheets having different sizes and has a function to compare a designated sheet size included in print data and the sizes of the recording sheet accommodated in the sheet cassettes. When the image forming apparatus judges that the designated sheet size does not match the feeding sheet sizes, the apparatus selects another feeding sheet size approximate to the designated sheet size and prints the print data on the recording sheet having the selected feeding sheet size by reducing or enlarging the print data. Accordingly, even when the sheet cassettes do not accommodate sheets having a desired size, the image forming apparatus disclosed in JP-A-2004-338189 can automatically perform printing on a sheet having a size most approximate to the desired size.

### SUMMARY

Aspects of the present invention provide an image forming apparatus and an image forming system which outputs appropriate content according to an image forming status when a recording sheet matching a sheet size requested for image forming of image data has run out and accurately urges a user to take a measure for a sheet feed error in order to improve usability.

### BRIEF DESCRIPTION OF THE DRAWINGS

FIG. 1 is a schematic diagram of an image forming system according to an aspect of the invention;

FIG. 2 is an external perspective view of the multifunction device shown in FIG. 1;

FIG. 3 is a vertical sectional view of the multifunction device of FIG. 2;

FIG. 4 is a control block diagram of the multifunction device of FIG. 2;

FIG. 5 are diagrams showing an example of image data, and FIG. 5A is an image diagram of image data and FIG. 5B is a diagram showing a data structure of the image data shown in FIG. 5A;

FIG. 6 is a diagram showing a variation of the data structure of the image data;

FIG. 7 is a control block diagram of the client PC shown in FIG. 1;

FIG. 8 is a flowchart of a receiving command processing program stored in the multifunction device shown in FIG. 2;

FIG. 9 is a flowchart of a printing processing program stored in the multifunction device shown in FIG. 2;

FIG. 10 is a flowchart of the printing processing program shown in FIG. 9; and

FIG. 11 is a table showing a relationship between sheet feed states and operations of the multifunction device when the printing processing program shown in FIG. 10 is executed (automatic designation).

### DETAILED DESCRIPTION

<General Overview>

According to an aspect of the invention, there is provided an image forming apparatus comprising: a plurality of sheet feed units, the respective sheet feed units corresponding to different sizes of recording sheet; an image forming unit which forms an image on the recording sheets based on image data; sheet presence detecting units each detecting presence of the recording sheets in the respective sheet feed units; a sheet size judging unit which judges whether the sizes of the recording sheets in the respective sheet feed units match a requested sheet size for image forming of the image data; a first output unit which performs a first output prior to the image forming by the image forming unit when the sheet size judging unit judges that a size of a recording sheet judged by the sheet presence detecting units to be present in at least one of the sheet feed units does not match a recording sheet of the requested sheet size; and a second output unit which performs second a output after the image forming is started when the sheet size judging unit judges that a size of a recording sheet judged by the sheet presence detecting units to be present in at least one of the sheet feed units does not match a recording sheet of the requested sheet size.

According to another aspect of the invention, there is provided an image forming system comprising: an image forming apparatus; and an external device which communicates with the image forming apparatus, wherein the image forming apparatus includes: a plurality of sheet feed units, the respective sheet feed units corresponding to different sizes of recording sheet; an image forming unit which forms an image on the recording sheets based on image data; a receiving unit which receives the image data from the external device; sheet presence detecting units each detecting presence of the recording sheets in the respective sheet feed units; a sheet size judging unit which judges whether the sheet sizes of the recording sheets in the respective sheet feed unit match a requested sheet size for image forming of the image data; a first output unit which performs a first output prior to the image forming by the image forming unit when the sheet size judging unit judges that a size of a recording sheet judged by the sheet presence detecting units to be present in at least one of the sheet feed units does not match a recording sheet of the requested sheet size; and a second output unit which performs a second output after the image forming is started when the sheet size judging unit judges that a size of a recording sheet judged by the sheet presence detecting units to be present in at least one of the sheet feed units does not match a recording sheet of the requested sheet size, and wherein the external device includes: a display unit which performs displaying according to the first output or the second output received from the image forming apparatus.

### <Illustrative Aspects>

An image forming apparatus and image forming system of the aspects of the invention will be described with reference to the accompanying drawings.

### (Image Forming System)

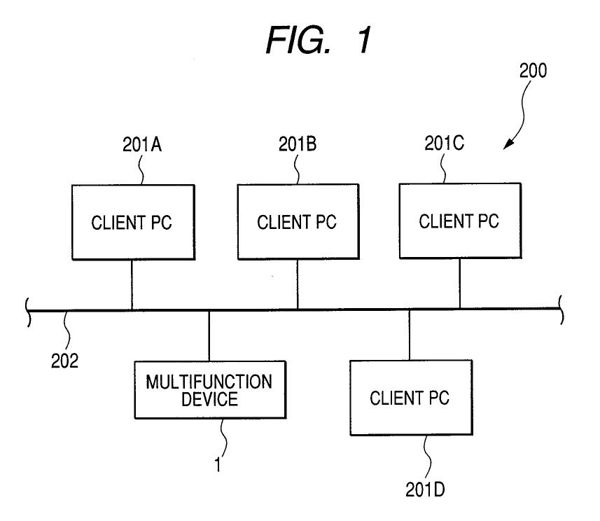

FIG. 1 is a schematic diagram of an image forming system 200 according to an aspect of the present invention.

The image forming system 200 is configured by connecting client personal computers functioning as an external equipment (hereinafter, abbreviated to “client PCs”) 201A, 201B, 201C, 201D, . . . , etc. to a multifunction device 1 functioning as an image forming apparatus via a network 202 functioning as a communicating unit in a manner enabling communications. Incidentally, if the client PCs do not need to be distinguished from each other, they are simply referred to as client PC 201 hereinafter. The network 202 includes a LAN, etc. The multifunction device 1 and the client PCs 201 may be connected one to one by using exclusive lines such as connection cables.

### (Multifunction Device)

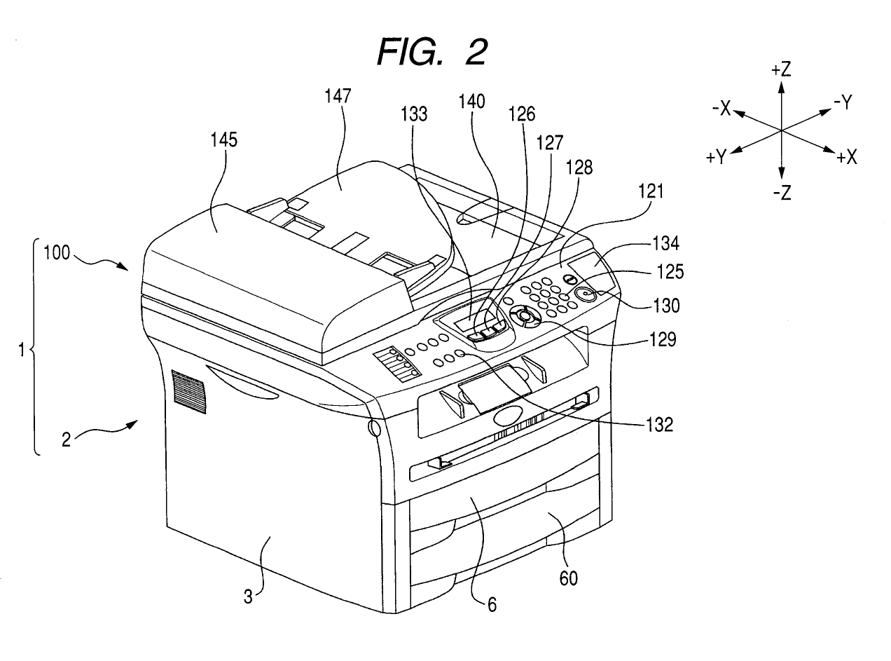

FIG. 2 is a perspective view of the multifunction device 1.

The multifunction device 1 is configured by arranging an image reading unit 100 on an upper side of an image forming unit 2 including a main body casing 3. The multifunction device 1 has a facsimile function, a scanner function, a printer function and a copy function. In the following description, the far direction of the multifunction device 1 is referred to as an X direction (front side is indicated as +X), the width direction is referred to as a Y direction (left front side in FIG. 2 is indicated as +Y), and the height direction is referred to as a Z direction (the upper side in FIG. 2 is indicated as +Z).

### (Image Forming Unit)

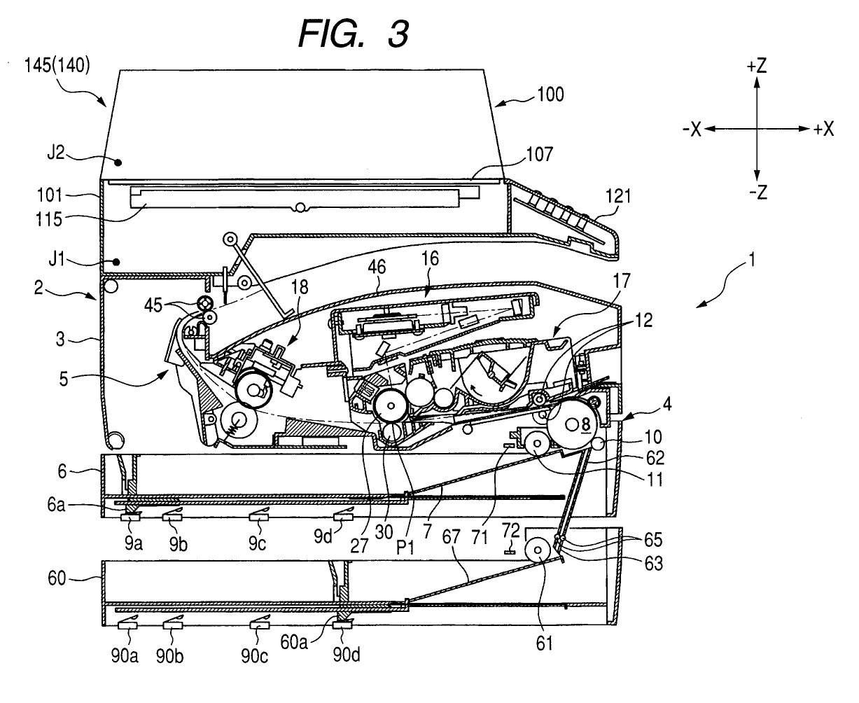

FIG. 3 is a vertical sectional view of the multifunction device 1.

The image forming unit 2 includes a recording sheet supply feeder 4 arranged on the bottom side of the main body casing 3 and an image forming part 5 for image forming arranged above the feeder.

In the feeder 4, a first tray 6 and a second tray 60 functioning as a sheet feed unit are arranged so as to overlap vertically on upper and lower stages on the bottom side of the multifunction device 1. The feeder 4 picks up a recording sheet to be accommodated in the first tray 6 by a feed-out roller 11, which is rotatably held on the front side of the first tray 6 on the upper stage, and conveys the sheet one by one to the image forming part 5 via a resister roller 12 from the section between a sheet feed roller 8 and a pinch roller 10 (indicated by double chained line of FIG. 3).

The first tray 6 has a thin tray shape. To the first tray 6, a sheet presser 7 is cantilevered, and an end of the sheet presser 7 closer to the sheet feed roller 8 can swing vertically. This sheet presser 7 has a spring that is not shown so as to be urged upward so that the upper surface of a leading end of the recording sheet placed on the first tray 6 is always in contact with the feed-out roller 11. The first tray 6 has an adjust lever 6a which is linearly reciprocatable along a conveying direction (X axis direction in the drawing) of the recording in accordance with the size of the recording sheets. The first tray 6 accommodates the recording sheets in a stacked manner.

The first tray 6 has a plurality of limit switches 9 functioning as a sheet size detecting unit, which are turned on/off by the adjust lever 6a, on a movement path of the adjust lever 6a. The limit switches 9 are provided at positions corresponding to sheet sizes of the recording sheet accommodated in the first tray 6. In this aspect, in the first tray 6, a limit switch 9a is provided at a position corresponding to the A4 size, a limit switch 9B is provided at a position corresponding to the Letter size, a limit switch 9c is provided at a position corresponding to the B5 size, and a limit switch 9d is provided at a position corresponding to a postcard size. Therefore, for example, when the adjust lever 6a presses the limit switch 9a and turns it on, the limit switch 9a outputs a signal of detection that the sheet size of the recording sheet to be accommodated in the first tray 6 is A4 size. In the description given below, when the limit switches do not need to be distinguished from each other, they are referred to as limit switches 9.

The presence of the recording sheet to be accommodated in the first tray 6 is detected by an optical sensor 71 functioning as a sheet presence detecting unit. The optical sensor 71 is attached to the casing 3 of the image forming unit 2 so that a projector thereof irradiates an unillustrated notched portion formed in the sheet presser 7 of the first tray 6 with detection light, and when the recording sheet is present in the first tray 6, the detection light reflects on the recording sheet and is inputted into a light receiver, and on the other hand, when no recording sheet exists in the first tray 6, the detection light passes through the unillustrated notched portion of the sheet presser 7 and is not received by the light receiver. Therefore, if reflected light is inputted into the light receiver the optical sensor 71 outputs a signal of detection that the recording sheet exists in the first tray 6. If the reflected light is not inputted into the light receiver, the optical sensor 71 outputs a signal of detection that no recording sheet exists in the first tray.

The feeder 4 picks up a recording sheet to be accommodated in the second tray 60 on the lower stage by the feed-out roller 61, conveys the sheet between the sheet feed roller 8 and the pinch roller 10 through guide members 63 and 62 from sheet feed rollers 65 and 65, and conveys the sheet one by one to the image forming part 5 in a conveying path (indicated by the long and short double dashed line of FIG. 3) similar to that of the recording sheet of the first tray 6. Since the structure of the second tray 60 is the same as the first tray 6, description thereof is omitted. A sheet presser 67 corresponds to the sheet presser 7, an adjust lever 60a corresponds to the adjust lever 6a, limit switches 90a through 90d functioning as a sheet size detecting unit which correspond to the limit switches 9a through 9d, and an optical sensor 72 functioning as a sheet presence detecting unit corresponds to the optical sensor 71.

Herein, in this aspect, the first tray 6 and the second tray 60 in tray shapes are used as the sheet feed unit. However, a manual sheet feed tray and a manual sheet feed port may also be used as the sheet feed unit. It is a matter of course that the number of trays is not limited to two.

In this aspect, the limit switches 9 and 90 are used as the sheet size detecting unit. However, optical sensors and magnetic sensors may also be used as the sheet size detecting unit.

Furthermore, in this aspect, the optical sensors 71 and 72 are used as the sheet presence detecting unit. However, piezoelectric elements and limit switches and the like may also be used as the sheet presence detecting unit.

The image forming part 5 functioning as an image forming unit includes a scanner 16, a process unit 17 and a fixing unit 18. In the image forming part 5, after evenly charging the surface of a photoconductor drum 27, the scanner 16 irradiates the surface of the photoconductor drum 27 with laser light and forms an electrostatic latent image. Then, the process gas unit 17 supplies toner onto the surface of the photoconductor drum 27 to visualize the electrostatic latent image, and forms a reverse image by transferring the visible image formed on the surface of the photoconductor drum 27 onto the recording sheet conveyed to an image forming position P1 between the photoconductor drum 27 and the transfer roller 30 from the feeder 4. The recording sheet on which the reverse image was formed is conveyed to the fixing unit 18. The fixing unit 18 heats and fixes the image onto the recording sheet.

On the downstream side of the image forming part 5, a sheet ejection roller 45 is provided to eject the recording sheet onto a copy receiving tray 46. On the main body casing 3 of the image forming unit 2, an image reading unit 100 is rotatably held via a first hinge shaft J1 and covers the upper side of the copy receiving tray 46.

### (Image Reading Unit)

As shown in FIG. 3, in the image reading unit 100, a document cover 140 is rotatably held on the upper casing 101 via a second hinge shaft J2 so that the document cover 140 opens and a document is placed on a platen glass 107, and an image on the document is read by an image sensor 115 housed inside the upper casing 101. The image reading unit 100 includes a known ADF mechanism 145, which enables to take in documents one by one from a document supply tray 147 (see FIG. 2) and pass the documents above the image sensor 115 in order to read images from the documents without moving the image sensor 115. An operating part 121 for setting and displaying printing conditions, etc., is provided on the front side (+X axis side of FIG. 3) of the image reading unit 100.

As shown in FIG. 2, the operating part 121 includes various keys such as an input key 125 for inputting a number of recording sheets to be subjected to image forming (printing, copying, etc.), a FAX mode key 126 for switching to a facsimile mode, a COPY mode key 127 for switching to a copy mode, a scan mode key 128 for switching to a scan mode, a navigation key 129 for setting operations such as the sheet size of the recording sheet to be subjected to image forming (printing, copying, etc.) and the kind of tray to be used for image forming (printing, copying, etc.) of the multifunction device 1 and a start key 130 for providing an operation start instruction to the multifunction device 1.

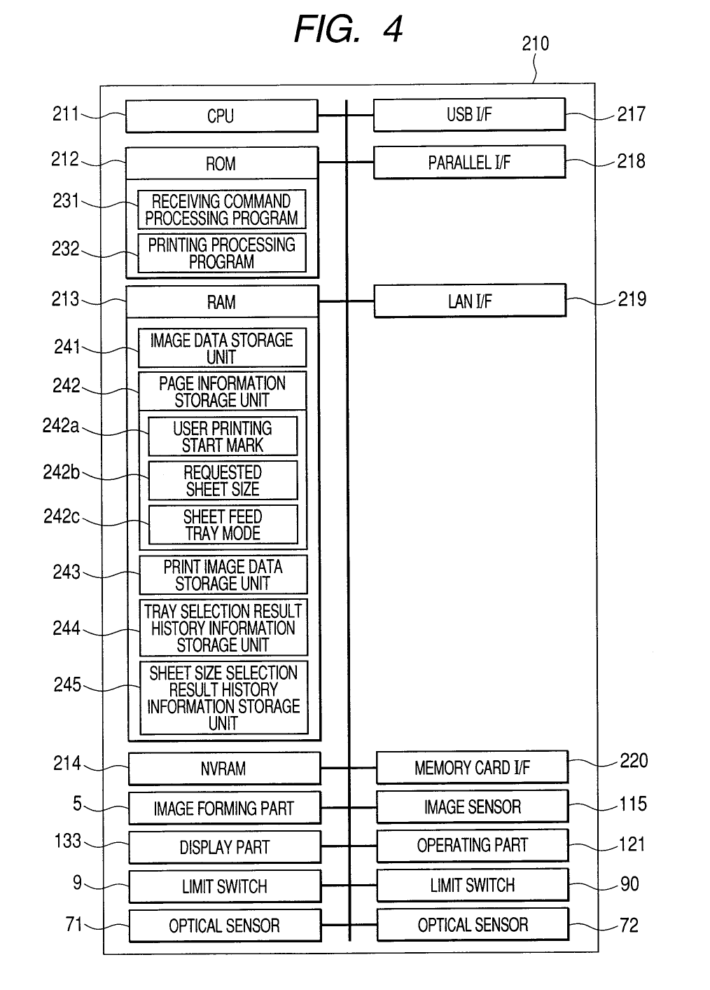

The operating part 121 includes an indication lamp 132 which visually outputs a mode being executed and warning, a display part 133 functioning as a display unit, and a speaker 134 for auditorily outputting, and so on. The display part 133 is a liquid crystal display panel such as LCD, and it is desirable that the display part can display a larger amount of data. However, in this aspect, due to arrangement of the keys and indication lamp 132, an LCD which displays data in 2 lines is employed as the display part 133. The multifunction device 1 includes a control device 210 installed inside as shown in FIG. 4, and its operations are controlled by the control device.

FIG. 4 is a control block diagram of the multifunction device 1 shown in FIG. 2.

The control device 210 is a general-purpose computer, and configured centering on a central processing unit (hereinafter, referred to as CPU) 211. A ROM 212, a RAM 213, an NVRAM 214, a USB interface (hereinafter, abbreviated to “USB I/F”) 217, a parallel interface (hereinafter, abbreviated to “parallel I/F”) 218, a LAN interface (hereinafter, abbreviated to “LAN I/F”) 219, a memory card interface (hereinafter, abbreviated to “memory card I/F”) 220, the image sensor 115, the image forming part 5, the display part 133, the operating part 121, the limit switches 9 and 90, and the optical sensors 71 and 72, etc., are connected to the CPU 211.

The CPU 211 performs data processing operation and administers operations of the multifunction device 1.

The ROM 212 is a read-only non-volatile memory, and stores various programs and data. In this aspect, the ROM 212 stores a receiving command processing program 231 and a printing processing program 232 functioning as a first output unit and a second output unit. The receiving command processing program 231 and the printing processing program 232 will be described later. In this aspect, the receiving command processing program 231 and the printing processing program 232 are stored in advance in the ROM 212. However, they may be stored in the NVRAM 214. Alternatively, the receiving command processing program 231 and the printing processing program 232 may be stored in a recording medium such as a CD-ROM and installed in the multifunction device 1 or downloaded to the multifunction device 1 from a website.

The RAM 213 is a volatile random-access memory. The RAM 213 temporarily stores data when the CPU 211 executes a program. In this aspect, the RAM 213 includes an image data storage unit 241, a page information storage unit 242, a print image data storage unit 243, a tray selection result history information storage unit 244 and a sheet size selection result history information storage unit 245.

The image data storage unit 241 stores image data inputted in the multifunction device 1. In this aspect, the image data means data which a user designates on a job unit basis concerning image forming (printing, copying, etc.) for forming an image on a recording sheet. The image data includes data inputted into the operating part 121 of the multifunction device 1 and data inputted into the multifunction device 1 from external equipment. For example, the image data may include data inputted into the operating part 121 of the multifunction device 1 at the time of copying, data inputted from the client PC 201 at the time of printing, and facsimile data received from a public phone network or the Internet in facsimile transmission, etc.

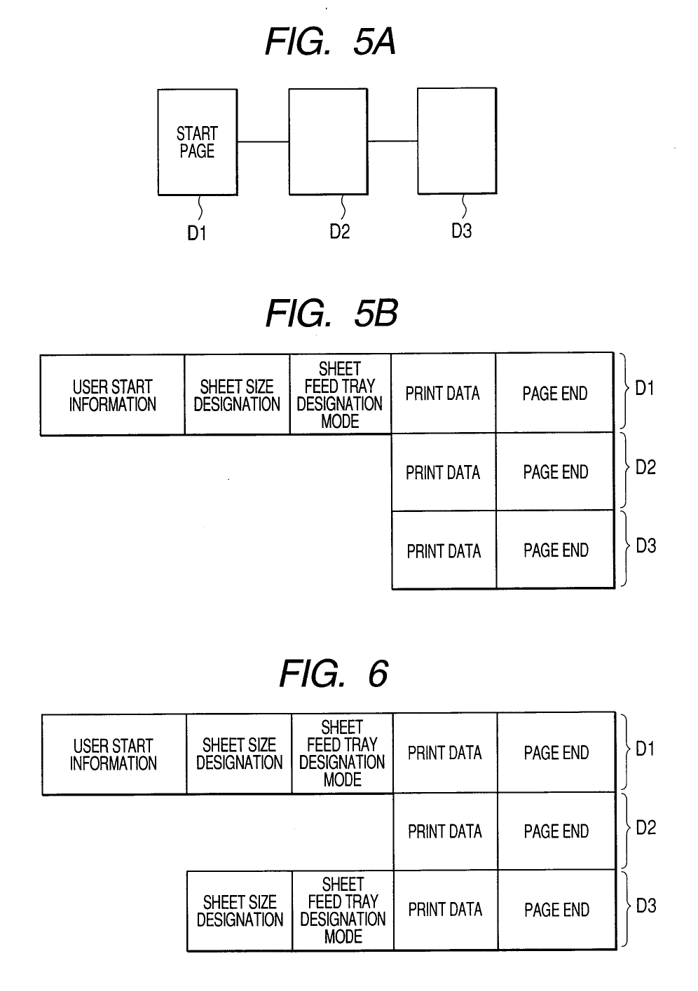

FIGS. 5A and 5B are diagrams showing examples of image data, in which FIG. 5A is an image diagram of image data, and FIG. 5B is a diagram showing a data structure of the image data shown in FIG. 5A.

For example, as shown in FIG. 5A, if a user inputs the image data for forming images on three sheets of recording sheets into the multifunction device 1, the inputted image data is stored in the image data storage unit 241 in the data structure shown in FIG. 5B.

As shown in FIG. 5B, the image data includes a plurality of receiving commands such as user start information, sheet size designation, sheet feed tray designation mode, print data, page end, etc. The receiving commands are composed on a page basis as indicated by D1, D2 and D3 shown in FIG. 5.

The user start information distinguishes certain image data from other image data and identifying a job unit. In this aspect, as shown in FIG. 5B, only one piece of user start information functioning as an image forming start information is provided at the head of the image data.

The sheet size designation designates a sheet size of a recording sheet to be subjected to image forming (printing, copying, etc.). In this aspect, Letter size, A4 size, B5 size, and postcard size can be set as the sheet size designation.

The sheet feed tray designation mode designates which of the first tray 6 and the second tray 60 the recording sheet is picked up from. In this aspect, Tray 1 (first tray 6) fixed designation, Tray 2 (second tray 6) fixed designation, or automatic designation can be set as the sheet feed tray designation mode.

In the image data shown in FIG. 5B, only data of the first page includes the receiving commands sheet size designation and sheet feed tray designation mode on the assumption that the sheet size and the sheet feed tray will not be changed during image forming. However, for example, when a user inputs image data which instructs printing of the first and second pages on an A4 size recording sheet picked up from the first tray 6 and printing of the third page on a Letter size recording sheet picked up from the second tray 60 into the multifunction device 1 as shown in FIG. 6, data D1 for the first page and data D3 for the third page contain the receiving commands sheet size designation and sheet feed tray designation.

The print data means data as an image forming object such as document data and diagrammatic data. The print data is contained in data of each page as shown in FIG. 5B.

The page end instructs a position at which image forming is ended on one sheet of a recording sheet. For example, a page breaking mark marked in a document corresponds to the page end. The page end is paired with the print data and contained in data of each page as shown in FIG. 5B.

In this aspect, image data includes a plurality of receiving commands. However, it is also possible to configure such that the image data includes only the print data, and the receiving commands of user start information, sheet size designation, sheet feed tray designation mode, and page end are sent separately from the image data.

The page information storage unit 242 stores page information. The page information is set in accordance with receiving commands corresponding to the image data in order to enable the multifunction device 1 to read conditions for image forming on a recording sheet. The page information includes the user printing start mark 242a, the requested sheet size 242b, and the sheet tray mode 242c.

The user printing start mark 242a is set based on the receiving command user start information, and is used by the multifunction device 1 to distinguish a job unit.

The requested sheet size 242b is set based on the receiving command sheet size designation, and is used by the multifunction device 1 to distinguish a sheet size requested for image forming of the image data.

The sheet feed tray mode 242c is set based on the receiving command sheet feed tray designation mode, and is used by the multifunction device 1 to distinguish the supply source of the recording sheet.

The print image data storage unit 243 stores print image data created based on the received command of print data.

The tray selection result history information storage unit 244 stores tray selection result history information as a history of a sheet feed tray selected at the time of image forming.

The sheet size selection result history information storage unit 245 stores sheet size selection result history information as a history of a sheet size selected at the time of image forming.

In this aspect, the tray selection result history information storage unit 244 and the sheet size selection result history information 245 store only the last tray selection result history information and sheet size selection result history information. However, past several pieces of the tray selection result history information and the sheet size selection result history information may be stored in the RAM 213 or the NVRAM 214, for example.

The NVRAM 214 is a nonvolatile random-access memory, and stores various programs and data.

The USB I/F 217, the parallel I/F 218 and the LAN I/F 219 are connected to external equipment via a connecting unit such as connection cables and input and output data. In this aspect, the LAN I/F 219 functioning as a receiving unit is connected to the network 202.

The memory card I/F 220 is for reading and writing data from and on a memory card.

The control device 210 automatically recognizes sheet sizes of the recording sheet to be accommodated in the first and second trays 6 and 60. The control device 210 receives signals outputted from the optical sensors 71 and 72 and automatically recognizes the presence of a recording sheet to be accommodated in the first and second trays 6 and 60.

### (Client PC)

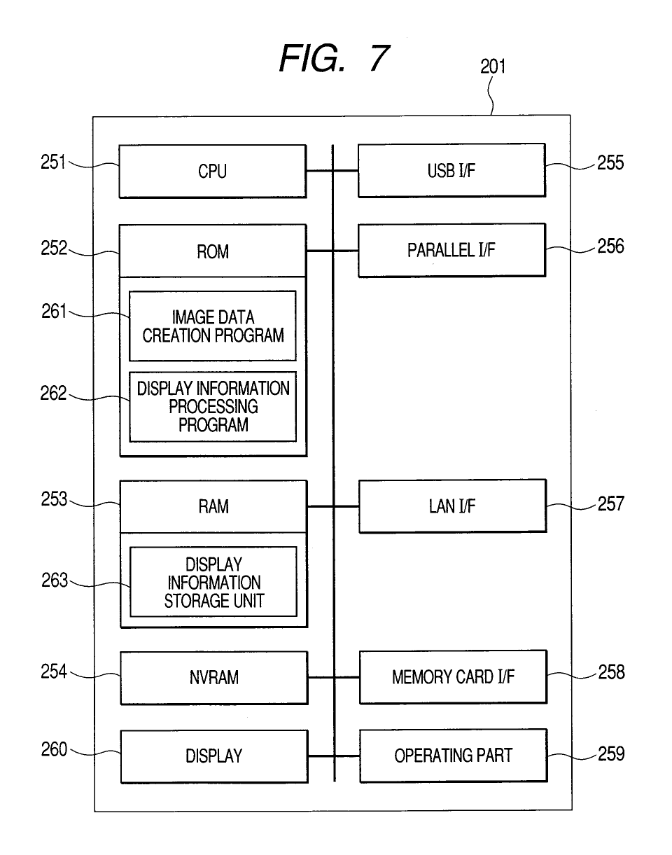

Next, the client PC 201 will be described. FIG. 7 is a control block diagram of the client PC 201 shown in FIG. 1.

The client PC 201 is a known computer and includes a CPU 251, a ROM 252, a RAM 253, an NVRAM 254, a USB I/F 255, a parallel I/F 256, a LAN I/F 257, a memory card I/F 258, an input part 259 and a display 260 functioning as a display unit.

The LAN I/F 257 of the client PC 201 is connected to the network 202 so that the client PC can exchange data with the multifunction device 1 and other client PCs.

The ROM 252 stores an image data creation program 261 and a display information processing program 262. The RAM 253 includes a display information storage unit 263.

The image data creation program 261 creates image data to be transmitted to the multifunction device 1. The display information processing program 262 stores display information received from the multifunction device 1 in the display information storage unit 263 and displays sheet feed error indication on the display 260 according to the display information. The client PC 201 may read the image data creation program 261 or display information processing program 262 from a CD-ROM and store it in the NVRAM 254. Incidentally, the client PC 201 may automatically or manually receive the image data creation program 261 or display information processing program 262 from the multifunction device 1 and store it in the NVRAM 254 when the client PC is connected to the multifunction device 1 via the network 202. The display information means data for making the display 260 display operations of the multifunction device 1. In this aspect, the display information includes sheet feed errors such as a sheet size error and sheet absence error.

### (Operations of Multifunction Device)

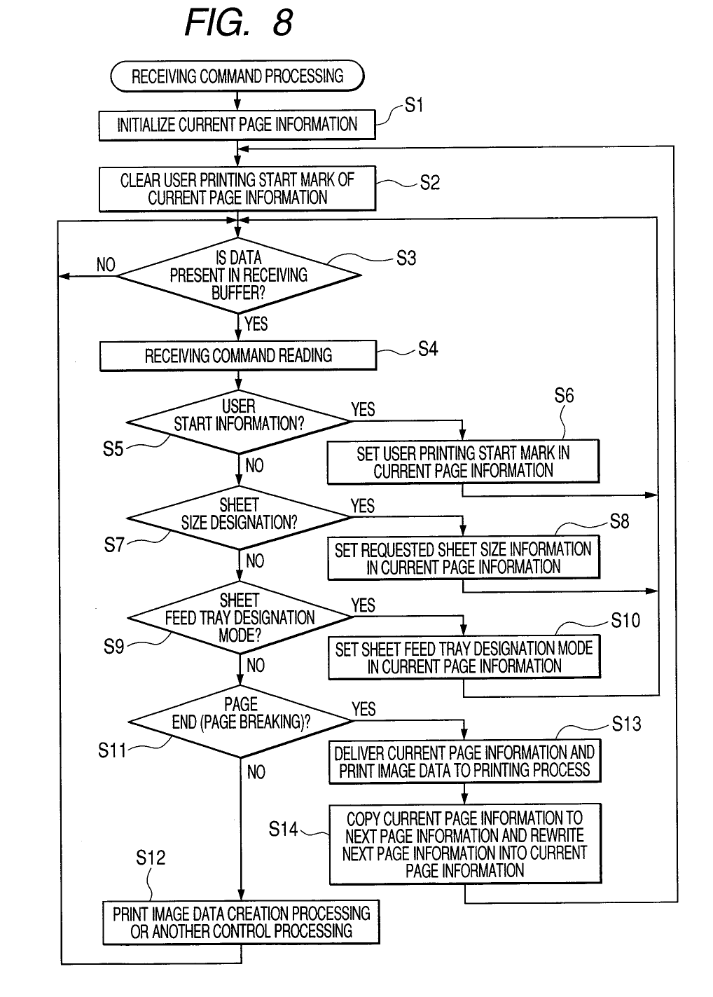

Operations of the multifunction device 1 will be described with reference to the flowcharts shown in FIG. 8 through FIG. 10.

The multifunction device 1 creates page information and print image data based on the image data inputted from the operating part 121 of the multifunction device 1 or the client PC 201, selects a tray for feeding a recording sheet and a sheet size of the recording sheet according to the page information, and creates print image data by picking up the recording sheet from the selected tray. When no recording sheet exists in the selected tray does not accommodate any recording sheet or when the size of the recording sheet accommodated in the selected tray is not a sheet size that a user designated, the multifunction device 1 changes the sheet feed error indication content according to the printing status and displays the changed content on at least either one of the display part 133 of the multifunction device 1 or the display 260 of the client PC 201. Hereinafter, the operations of the multifunction device 1 will be described in detail.

### (Receiving Command Processing)

FIG. 8 is a flowchart of the receiving command processing program 231 stored in the multifunction device 1 shown in FIG. 2.

The multifunction device 1 starts the receiving command processing program 231 when the power source thereof is turned on. After started up, the receiving command processing program 231 inquires to the image data storage unit 241 about the presence of image data at predetermined time intervals. If the receiving command processing program 231 detects that the image data is stored in the image data storage unit 241, the program creates print image data and page information according to the detected image data and delivers both of the print image data and the page information to the printing process.

When the power source of the multifunction device 1 is turned on, the receiving command processing program 231 initializes current page information stored in the page information storage unit 242 at Step 1 (hereinafter, abbreviated to S1). The process goes to S2 and clears the user start mark 242a of the current page information. The process goes to S3 and confirms whether image data exists in the image data storage unit 241 that becomes a receiving buffer. If no image data exists in the image data storage unit 241 (S3: NO), the process waits until the image data is inputted.

On the other hand, if the image data exists in the image data storage unit 241, the process goes to S4 and reads one receiving command from the image data in the image data storage unit 241. The process goes to S5 and judges whether the receiving command read at S4 is user start information. If the receiving command read at S4 is user start information (S5: YES), the process goes to S6 and sets a user printing start mark 242a in an area for storing current page information provided in the page information storage unit 242. Accordingly, the multifunction device 1 can recognize that the current process is in a state before starting printing based on the one image data. Thereafter, the process returns to S3 and continues processing.

On the other hand, if the receiving command read at S4 is not user start information (S5: NO), the process goes to S7 and judges whether the receiving command read at S4 is sheet size designation. If the receiving command read at S4 is sheet size designation (S7: YES), the process goes to S8 and set the requested sheet size 242b in an area for storing current page information provided in the page information storage unit 242. Then, the process returns to S3 and continues processing. In detail, if the sheet size designation is A4 size, A4 size is set as the requested sheet size 242b in the current page information of the page information storage unit 242.

On the other hand, if the receiving command read at S4 is not sheet size designation (S7: NO), the process goes to S9 and judges whether the receiving command read at S4 is sheet feed tray designation mode. If the receiving command read at S4 is sheet feed tray designation mode (S9: YES), the process goes to S10 and set the sheet feed tray mode 242c in the area for storing current page information provided in the page information storage unit 242. Then, the process returns to S3 and continues the processing. In detail, if the sheet feed designation mode set by a user is automatic designation, automatic designation is set as the sheet feed tray mode 242c in the current page information of the page information storage unit 242.

On the other hand, if the receiving command read at S4 is not sheet feed tray designation mode (S9: NO), the process goes to S11 and judges whether the receiving command read at S4 is page end (for example, page breaking). If the receiving command read at S4 is not page end (S11: NO), the process goes to S12 and performs print data creation processing or another control processing. Accordingly, the print image data is created and stored in the print image data storage unit 243. Thereafter, the process returns to S3 and continues processing.

On the other hand, if the receiving command read at S4 is page end (S11: YES), the process goes to S13 and sends a receiving command processing completion signal informing that the creation of the current page information and print image data has been completed to the printing processing. Accordingly, the current page information and print image data are delivered to the printing process. Then, the process goes to S14. If printing on three sheets of recording sheet is performed as shown in FIG. 5, for example, the current (first page or second page) page information of the page information storage unit 242 is copied to the next (second page when the current is the first page, and third page when the current is the second page) to rewrite the next page information (second page when the current is the first page, and third page when the current is the second page) into the current page information. Thereby, the current page information is succeeded by the next page information. Thereafter, the process returns to S2 and continues the processing. Incidentally, the process returns to S2 but not S3 and clears the user printing start mark. The reason is to make the multifunction device 1 to recognize that the current state is a state after starting printing based on one image data.

In the image data, although the sheet size designation (for example, A4 size) and the sheet feed tray designation mode (for example, automatic designation) are the same between the first page and the second page, the sheet size designation (for example, Letter size) and the sheet feed tray designation mode (for example, Tray (first tray 6) designation) are different in the third page in some cases, as shown in FIG. 6. In this case, the page information (user printing start mark 242a, requested sheet size: A4 size, sheet feed tray mode: automatic designation) is created according to the above-described steps (see S3: YES, S4, S5: YES, S6, S7: YES, S8, S9: YES, S10, S11: NO, S12, S11: YES, and S13 of FIG. 8) for the first page. For the second page, since the printing based on one image data is starting while succeeding page information of the first page (see S14 of FIG. 8), the user printing start mark 242a is cleared (see S2 of FIG. 8), and the page information (requested sheet size: A4 size, sheet feed tray mode: automatic designation) is created (see S3: YES, S4, S5: NO, S7: NO, S9: NO, S11: NO, S12, S11: YES, S13 of FIG. 8). Furthermore, for the third page, after succeeding the page information of the second page (see S14 of FIG. 8), the requested sheet size 242b and sheet feed tray mode 242c of the succeeded page information are changed (see S7: YES, S8, S9: YES, and S10 of FIG. 8), and the page information (requested sheet size: Letter size, sheet feed tray mode: Tray 1 designation) are created (see S3: YES, S4, S5: NO, S7: YES, S8, S9: YES, S10, S11: No, S12, S11: YES, and S13 of FIG. 8).

### (Printing Processing)

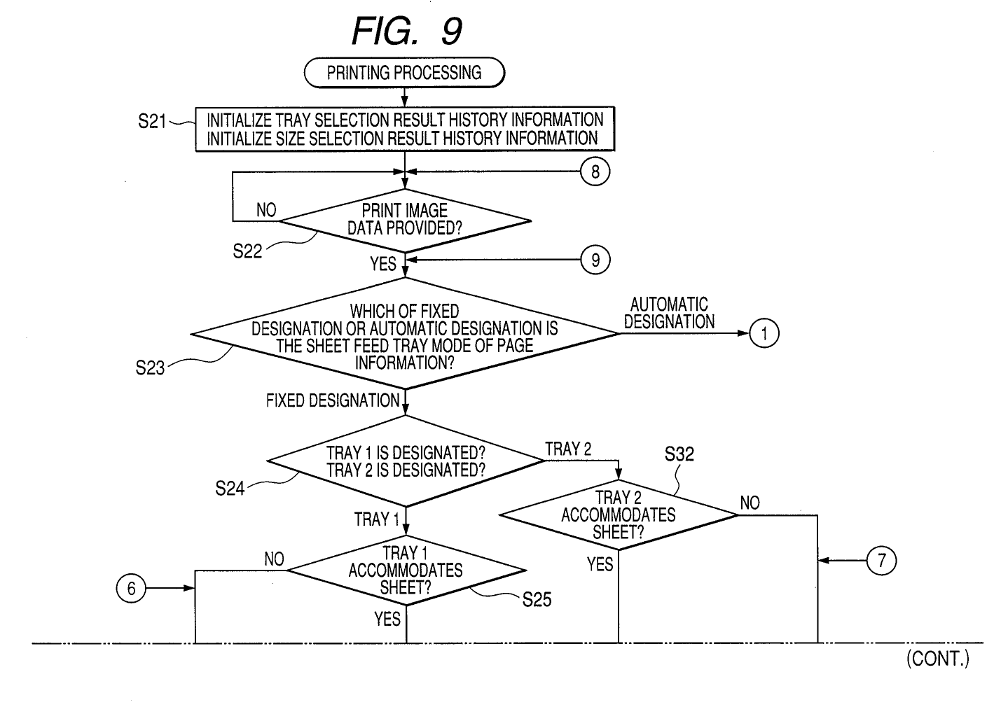

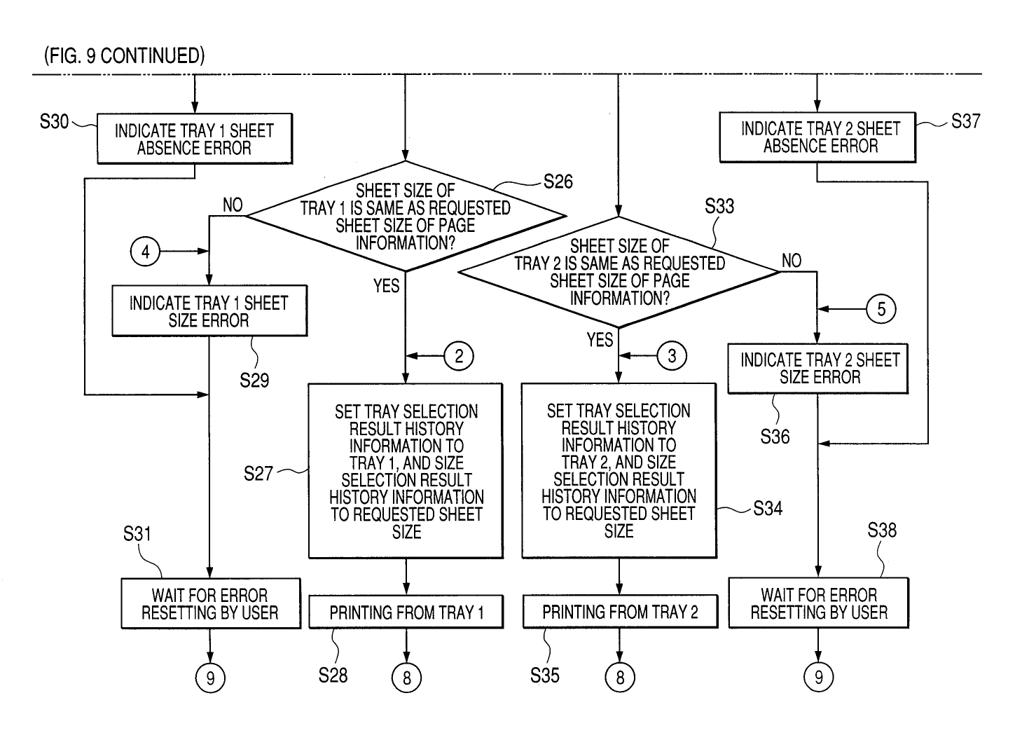

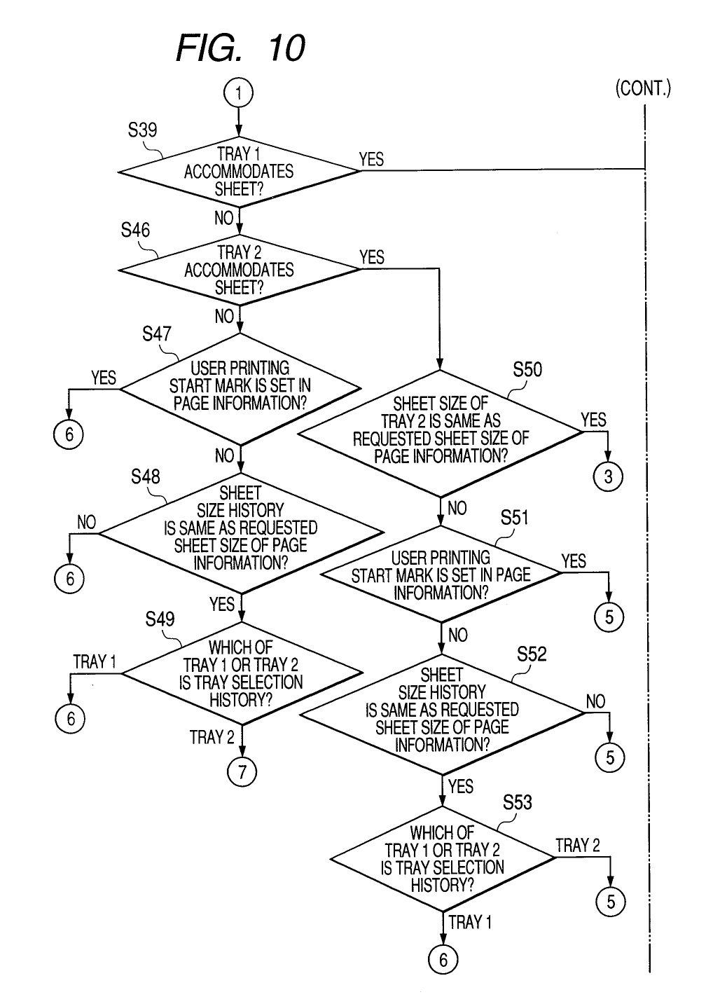

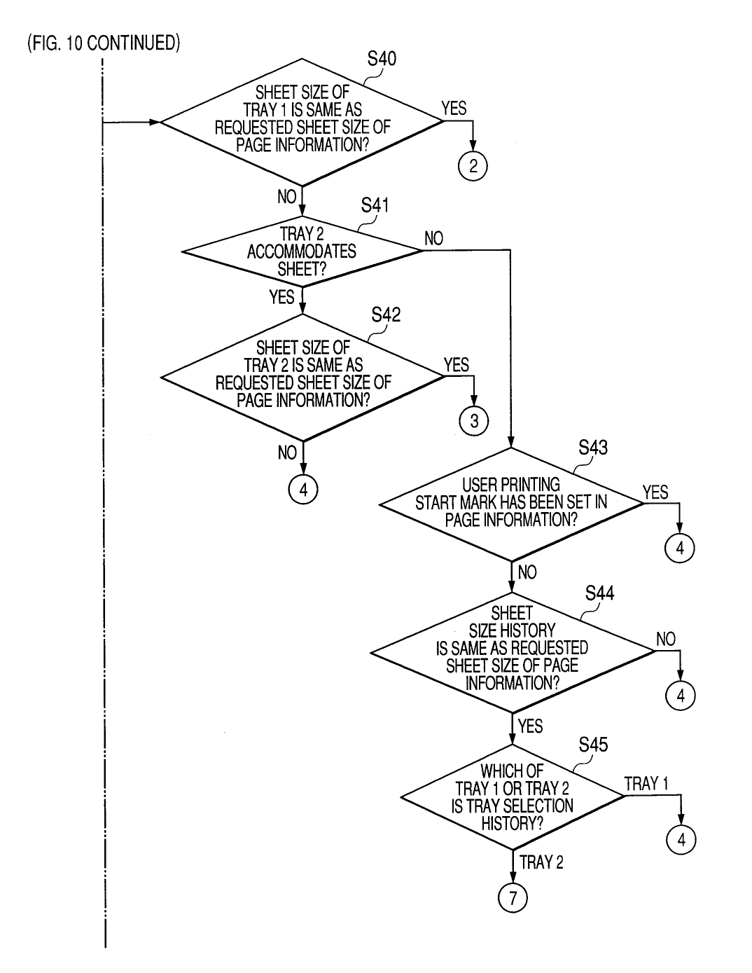

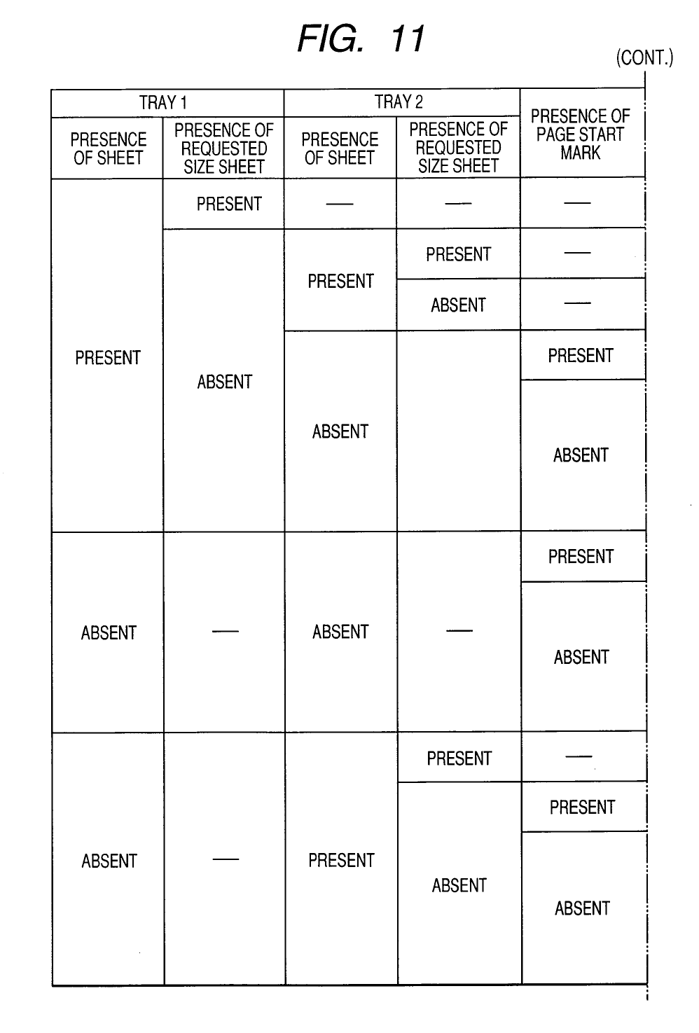

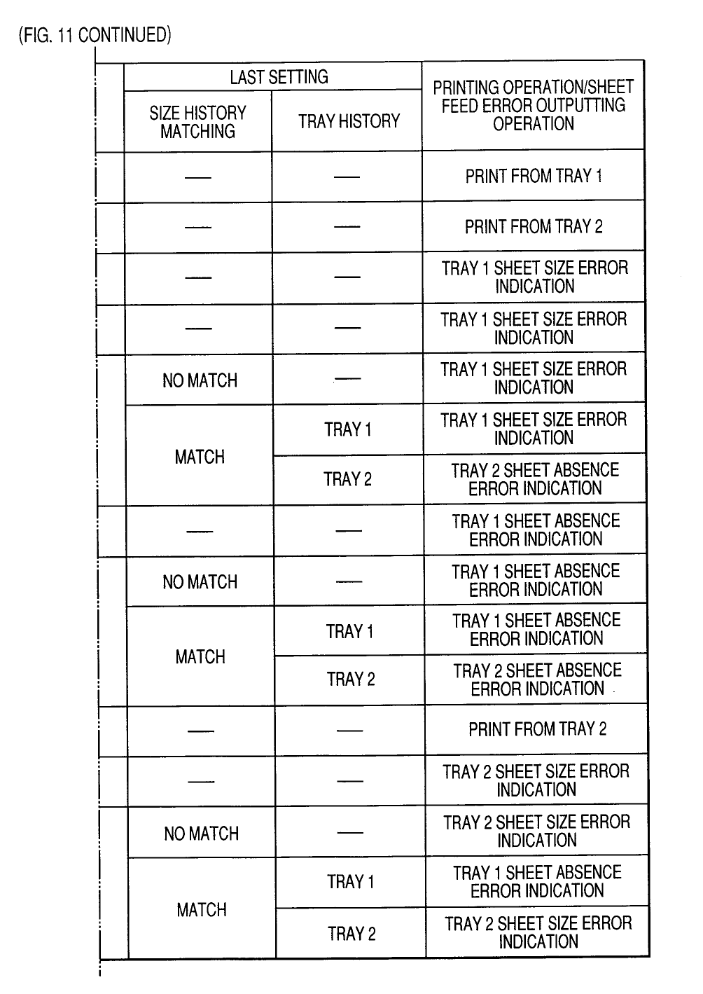

FIG. 9 and FIG. 10 are flowcharts of the printing processing program 232. FIG. 11 is a table showing a relationship between a sheet feed state and the multifunction device when the printing processing program 232 shown in FIG. 10 is executed (automatic designation).

The multifunction device 1 starts the printing processing program 232 when the power source is turned on. The printing processing program 232 shown in FIG. 9 and FIG. 10 not only prints the print image data on the recording sheet according to the page information delivered from the receiving command processing shown in FIG. 8 but also indicates a warning when a sheet feed error occurs before or after the printing start. When the sheet feed tray mode 242c is automatic designation, and a recording sheet is present in at least either one of the first tray 6 or the second tray 60 but a recording sheet having a desired sheet size is not present in the first tray 6 and the second tray 60 and causes a sheet feed error (see FIG. 11), the printing processing program 232 changes the warning indication, which informs the content of a sheet feed error, in accordance with the printing status (before or after printing start).

When the power source of the multifunction device 1 is turned on, the printing processing program 232 initializes the tray selection result history information and initializes the size selection result history information at S21 of FIG. 9. Then, the process goes to S22, receives a receiving command processing completion signal from the receiving command processing and judges whether it has been confirmed that print image data exists in the print image data storage unit 243. Until a receiving command processing completion signal is received from the receiving command processing, the process judges that the print image data is not present in the print image data storage unit 243 (S22: NO) and waits until page information and print image data are prepared. On the other hand, if the print image data is present in the print image data storage unit 243 (S22: YES), the process goes to S23 and judges whether the sheet feed tray mode 242c of the page information is fixed designation or automatic designation. The case of judgment of automatic designation will be described after describing fixed designation by referring to FIG. 9.

### (Fixed Designation)

As shown in FIG. 9, if the sheet feed tray mode of the page information is the fixed designation (S23: fixed designation), the process goes to S24 and judges which of Tray 1 (first tray 6) and Tray 2 (second tray 60) is designated.

If Tray 1 is designated (S24: tray 1), the process goes to S25 and judges whether the recording sheet exists in Tray 1 (first tray 6). The multifunction device 1 automatically recognizes the presence of the recording sheet to be accommodated in the first tray 6 based on a signal, which the optical sensor 71 outputs when it receives reflected light reflected from the surface of the recording sheet. If the control device 210 inputs a signal that the optical sensor 71 outputs when it receives the reflected light, the multifunction device 1 judges that the recording sheet exists in the first tray 6 (S25: YES) and judges whether the sheet size of the first tray 6 is the same as the requested sheet size 242b of the page information at S26.

The multifunction device 1 automatically recognizes the sheet size of the first tray 6 by detecting ON states of the limit switches 9a through 9d provided in the first tray 6, and judges the sheet size based on whether the sheet size of the first tray 6 is the same as the requested sheet size 242b of the page information storage unit 242. For example, when the requested sheet size 242b is A4 size, if the limit switch 9a of the first tray 6 is ON, it is judged that the sheet size of the first tray 6 is A4 size and is the same as the requested sheet size 242b. On the other hand, if the limit switch 9b of the first tray 6 is ON, it is judged that the sheet size of the first tray 6 is the Letter size and is not the same as the requested sheet size 242b.

If the sheet size of the first tray 6 is the same as the requested sheet size of the page information (S26: YES of FIG. 9), the process goes to S27, rewrites the tray selection result history information of the tray selection result history information storage unit 244 into Tray 1 and rewrites the sheet size selection result history information of the sheet size selection result history information storage unit 245 into requested sheet size 242b. The reason for rewriting the tray selection result history information and the sheet size selection result history information is to select a tray and sheet size by using the last selected tray or sheet size when a user sets the selection of the sheet tray to automatic setting (described later). That is, if a plurality of printing processing are performed based on one image data, generally, it is considered that a tray or sheet size selected for certain printing processing is the same as a tray or sheet size selected for the printing processing immediately before this. Then, the process goes to S28, performs printing by picking up the recording sheet from the first tray 6 and returns to S22. The process waits until the next print image data is prepared.

On the other hand, if the sheet size of the first tray 6 is not the same as the requested sheet size 242b of the page information (S26: NO), the process goes to S29 and indicates a sheet size error of the first tray 6. Then, the process goes to S31 and waits until the user resets the error. For example, when the designated sheet size is the Letter size and the sheet size of the first tray 6 is A4 size, if the user replaces the A4 size recording sheet to be accommodated in the first tray 6 with Letter size recording sheet, in the multifunction device 1, the limit switch 9a of the first tray 6 is switched from ON to OFF, and on the other hand, the limit switch 9b is switched from OFF to ON, and the sheet size of the first tray 6 is changed from A4 size to Letter size. Accordingly, the multifunction device recognizes that the sheet size error has been reset. Then, the process returns to S23 and performs the printing processing of this print image data again. Since this sheet size error resetting method is the same as the sheet size error resetting method described later, description thereof is omitted as appropriate hereinafter.

On the other hand, if the control device 210 does not input a signal which the optical sensor 71 outputs when it receives the reflected light at S25, it is judged that no recording sheet exists in the first tray 6 (S25:NO). The process goes to S30 and indicates a recording sheet absence error of Tray 1 (first tray 6). Then, the process goes to S31 and waits until a user resets the error. For example, when the sheet size of the first tray 6 is A4 size and a user replenishes A4 size recording sheet in the first tray 6, the multifunction device 1 inputs a signal from the optical sensor 71 for informing that the optical sensor 71 received reflected light from the recording sheet and detected the recording sheet and the multifunction device 1 recognizes that the sheet absence error has been reset. Then, the process returns to S23 and performs printing processing of this print image data again. Since this sheet absence error resetting method is the same as the sheet size error resetting method described later, description is omitted as appropriate hereinafter.

If Tray 2 (second tray 60) is designated (S24: Tray 2), the process goes to S32 and judges whether the recording sheet exists in the second tray 60. Since the detection of the presence of the sheet in the second tray 60 is the same as that of the first tray 6, description thereof is omitted (the same applies to the following). If the recording sheet exists in the second tray 60 (S32: YES), the process goes to S33 and judges whether the sheet size of the second tray 60 is the same as the requested sheet size 242b of the page information. Since the judgment as to whether the sheet size of the second tray 60 and the requested sheet size 242b are the same is the same as the judgment as to whether the sheet size of the first tray 6 and the requested sheet size 242b are the same, description thereof is omitted (the same applies to the following). If the sheet size of the second tray 60 is the same as the requested sheet size 242b of the page information (S33: YES), the process goes to S34, rewrites the tray selection result history information of the sheet size selection result history information storage unit 244 into Tray 2 and rewrites the sheet size selection result history information of the sheet size selection result history information storage unit 245 into requested sheet size 242b. Since the reason and method for updating the tray selection result history information and the sheet size selection result history information are the same as that of S27, the description is omitted (the same applies to the following). Then, the process goes to S35, picks the recording sheet up from the second tray 60 and performs printing. Then, the process returns to S22 and waits until the next print image data is prepared.

On the other hand, if the sheet size of the second tray 60 is not the same as the requested sheet size 242b of the page information (S33: NO), the process goes to S36 and indicates a sheet size error of the second tray 60. Thereafter, the process goes to S38 and waits until a user resets the error. When the user resets the error, the process returns to S23 and performs printing processing of this print image data again.

In contrast, if no recording sheet exists in the second tray 60 (S32: NO), the process goes to S37 and indicates a sheet absence error of the second tray 60. Then, the process goes to S38 and waits until a user resets the error. When the user resets the error, the process returns to S23 and performs printing processing of this print image data again.

Summarizing the sheet feed error indication in the case of fixed designation, if no recording sheet exists in the fixed-designated tray, a sheet absence error is indicated on at least either one of the display part 133 of the multifunction device 1 or the display 260 of the client PC 201. When the sheet size of the fixed-designated tray is not the same as the sheet size that the user designated, a sheet size error is indicated on at least either one of the display part 133 of the multifunction device 1 or the display 260 of the client PC 201.

### (Automatic Designation)

The case where the sheet feed tray select mode of page information is automatic designation (S23: automatic designation) will be described with reference to FIG. 10.

In this aspect, as a precondition of automatic designation for automatically selecting a tray from which the recording sheet is fed by the multifunction device 1, it is assumed that the priority of the first tray 6 over the second tray 2 is set. It is a matter of course that the order of priority is not limited to this.

At S39 of FIG. 10, it is judged whether the recording sheet exists in Tray 1 (first tray 6). If the recording sheet exists in the first tray 6 (S39: YES), the process goes to S40 and judges whether the sheet size of the first tray 6 is the same as the requested sheet size 242b of the page information. If the sheet size of the first tray 6 is the same as the requested sheet size 242b of the page information (S40: YES), the process goes to S27 of FIG. 9, performs printing on the recording sheet in the first tray 6 (see FIG. 11). Since the S27 and subsequent processing are described above, description thereof is omitted here.

On the other hand, as shown in FIG. 10, if the sheet size of the first tray 6 is not the same as the requested sheet size 242b of the page information (S40: NO), the process goes to S41 and judges whether the recording sheet exists in the second tray 60. If the recording sheet exists in the second tray 60 (S41: YES), the process goes to S42 and judges whether the sheet size of the second tray 60 is the same as the requested sheet size 242b of the page information. If the sheet size of the second tray 60 is the same as the requested sheet size 242b of the page information (S42: YES), the process goes to S34 of FIG. 9 and performs printing on the recording sheet of the second tray 60 (see FIG. 11). Since the S34 and subsequent processing are described above, the description thereof is omitted here.

On the other hand, as shown in FIG. 10, if the sheet size of the second tray 60 is not the same as the requested sheet size 242b of the page information (S42: NO), the process goes to S29 and makes at least either one of the display part of the multifunction device 1 or the display 260 of the client PC 201 display a sheet size error of Tray 1 (first tray 6) (see FIG. 11). Even when the recording sheet exists in the first and second trays 6 and 60, if the sheet sizes of these are not the same as the requested sheet size 242b, printing that meets the user's requirements is not performed by using the recording sheet in any of the first and second trays 6 and 60. Thus, the multifunction device 1 informs the user of the sheet size error of the first tray 6 via at least either one of the display part 133 of the multifunction device 1 or the display 260 of the client PC 201 according to the precondition that the first tray 6 is given priority over the second tray 60. If the multifunction device 1 confirms that the sheet feed error has been reset by a user by taking a measure such as replacing the recording sheet in the first tray 6 with a recording sheet with the requested sheet size 242b or inputting an instruction to process the print image data so that it falls within the recording sheet of the first tray 6 and continues the printing, the process returns to S23 of FIG. 9 and performs printing processing of this print image data again.

In contrast, at S41 of FIG. 10, if no recording sheet exists in the second tray 60 (S41: NO), the process goes to S43 and judges whether the user printing start mark 242a has been set in the page information. If the user printing start mark 252a has been set in the page information (S43: YES), this means that the process is before starting the printing of one image data. Thus, the process goes to S29 of FIG. 9 and makes at least either one of the display part 133 of the malfunction printer 1 or the display 260 of the client PC 201 display the sheet size error of Tray 1 (first tray 6) (see FIG. 11). If no recording sheet exists in the second tray 60, when the sheet size of the recording sheet accommodated in the first tray 6 is not the same as the requested sheet size 242b (see S39: YES, S40: NO, and S41: NO of FIG. 10), the multifunction device 1 cannot perform printing that meets the user's requirements even by performing printing on the recording sheet of the first tray 6 that is given priority. Incidentally, before starting the printing (see S43: YES of FIG. 10), it is unknown whether the user desires printing on a recording sheet of a size that the user designated or permits printing on a recording sheet of a size different from the sheet size that the user designated. Therefore, the multifunction device 1 informs the user of the sheet size error of the first tray 6 via at least either one of the display part 133 of the multifunction device 1 or the display 260 of the client PC 201. When the multifunction device 1 confirms that the user looked at the sheet size error indication of the first tray 6 and reset the sheet feed error by taking a measure such as replacing the recording sheet of the first tray 6 or printing on a recording sheet of a size different from the designated sheet size (see S31 of FIG. 9), the process returns to S22 and waits until the next print image data is prepared.

On the other hand, as shown in FIG. 10, if the user printing start mark 242a is not set in the page information (S43: NO), it is judged that the process is after starting printing based on one image data. Thus, the process judges whether the sheet size selection result history information of the sheet size selection result history information storage unit 245 is the same as the requested sheet size 242b of the page information at S44. If the sheet size selection result history information is not the same as the requested sheet size 242b of the page information (S44: NO), the process goes to S29 of FIG. 9 and indicates a sheet size error of the first tray 6 on at least either one of the display part 133 of the multifunction device 1 or the display 260 of the client PC 201 (see FIG. 11). If no recording sheet exists in the second tray 60 and the sheet size of the recording sheet to be accommodated in the first tray 6 is different from the designated sheet size (see S39: YES, S40: NO, S41: NO of FIG. 10), and if the sheet size is different from the sheet size selection result history information (see S44: NO of FIG. 10), this state means that the user desires to change the sheet size. Therefore, the multifunction device 1 indicates a sheet size error of the first tray 6 on at least either one of the display part 133 of the multifunction device 1 or the display 260 of the client PC 201. Accordingly, the user is informed that the recording sheet in the first tray 6 must be replaced with a recording sheet with another size. When the multifunction device 1 confirms that the user reset the sheet feed error by replacing the recording sheet in the first tray 6 with the recording sheet of a desired sheet size, the process returns to S23 of FIG. 9 and performs printing processing of this print image data again.

On the other hand, as shown in FIG. 10, if the sheet size selection result history information is the same as the requested sheet size 242b of the page information (S44: YES), it is judged that the user does not desire to change the last printing processing and sheet size. Thus, the process goes to S45 and judges whether the tray selection result history information of the tray selection result history information storage unit 244 is Tray 1 (first tray 6) or Tray 2 (second tray 60). In the multifunction device 1, priority of the first tray 6 over the second tray 60 is set. However, after printing starts based on one image data, it is considered that the tray to be selected is often the same tray as that of the last printing processing. Accordingly, it is reasonable that the tray selected for the last printing processing is selected by priority.

If the tray selection result history information is Tray 1 (S45: Tray 1), the process goes to S29 of FIG. 9 and indicates a sheet size error of the first tray 6 on at least either one of the display part 133 of the multifunction device 1 or the display 260 of the client PC 201 (see FIG. 11). It is presumed that in the first tray 6 selected in the last printing processing immediately before this printing processing, a recording sheet having a sheet size selected in the last printing processing is accommodated. However, at S45, it is judged that the sheet size of the recording sheet accommodated in the first tray 6 is not the same as the requested sheet size 242b (see S39: YES, S40: NO, S41: NO, S43: NO, S44: YES, and S45: Tray 1 of FIG. 10). Therefore, the multifunction device 1 informs the user that the recording sheet in the first tray 6 must be replaced with a recording sheet of a desired sheet size by indicating the sheet size error of the first tray 6 on at least either one of the display part 133 of the multifunction device 1 or the display 260 of the client PC 201. When the multifunction device 1 confirms that the user reset the sheet feed error by replacing the recording sheet of the first tray 6 with the recording sheet of a desired sheet size, the process returns to S23 of FIG. 9 and performs printing processing of this print image data again.

As shown in S45 of FIG. 10, if the tray selection result history information is Tray 2 (S45: Tray 2), the process goes to S37 of FIG. 9 and indicates a sheet absence error of the second tray 60 at least either one of the display part 133 of the multifunction device 1 or the display 260 of the client PC 201 (see FIG. 11). It is presumed that the second tray 60 selected immediately before this printing processing accommodates the recording sheet of a selected size immediately before this printing processing. However, no recording sheet exists in the second tray 60 (see S41: S4 of FIG. 10). Therefore, the multifunction device 1 indicates a sheet absence error of the second tray 60 on at least either one of the display part 133 of the multifunction device 1 or the display 260 of the client PC 201. Accordingly, the multifunction device 1 informs the user of the necessity for replenishment of the recording sheet of the same sheet size as that of the recording sheet accommodated in the second tray 60 into the second tray 60. When the multifunction device 1 confirms that the user reset the sheet feed error by replenishing the recording sheet into the second tray 60, the process returns to S23 of FIG. 9 and performs printing processing of this print image data again.

In contrast, if no recording sheet exists in Tray 1 (first tray 6) (S39: NO) at S39 of FIG. 10, the process judges whether the recording sheet exists in Tray 2 (second tray 60) at S46. If no recording sheet exists in Tray 2 (S46: NO), the process goes to S47 and judges whether the user printing start mark 242a has been set in the page information. If the user printing start mark 242a has been set in the page information (S47: YES), it is judged that the process is before starting printing based on one image data. Thus, the process goes to S30 of FIG. 9 and indicates a sheet absence error of the first tray 6 on at least either one of the display part 133 of the multifunction device 1 or the display 260 of the client PC 201 (see FIG. 11). If no recording sheet exists in any of the first and second trays 6 and 60, printing on the recording sheet is not possible. Incidentally, before printing start, it is unknown whether the user considers that printing on a recording sheet of a designated sheet size is necessary or permits printing on a recording sheet that does not have the designated sheet size. Therefore, the multifunction device 1 indicates a sheet absence error of the first tray 6 on at least either one of the display part 133 of the multifunction device 1 or the display 260 of the client PC 201 according to the precondition that the first tray 6 is given priority over the second tray 60. Accordingly, the multifunction device urges the user to take a measure of replenishing the recording sheet into the first tray 6. When the multifunction device 1 confirms that the user reset the sheet feed error by replenishing the recording sheet into the first tray 6, the process returns to S23 of FIG. 9 and performs printing processing of this print image data again.

On the other hand, as shown in FIG. 10, if the user printing start mark 242a is not set in the page information (S47: NO), the process goes to S48 and judges whether the sheet size selection result history information of the sheet size selection result history information storage unit 245 is the same as the requested sheet size 242b of the page information. If the sheet size selection result history information is not the same as the requested sheet size 242b of the page information (S48: NO), the process goes to S30 of FIG. 9 and indicates a sheet absence error of the first tray 6 on at least either one of the display part 133 of the multifunction device 1 or the display 260 of the client PC 201 (see FIG. 11). If no recording sheet exists in the first tray6 and the second tray 60, the difference of the sheet size from the sheet size selection result history information means that the user desires to change the sheet size in the middle of printing. In this case, it is expected that the user will take a measure of putting a recording sheet of another sheet size into the first tray 6 by adjusting the adjust lever 6a. Therefore, the multifunction device 1 indicates a sheet absence error of the first tray 6 on at least either one of the display part 133 of the multifunction device 1 or the display 260 of the client PC 201 according to the precondition that the first tray 6 is given priority over the second tray 6e. Accordingly, the multifunction device 1 informs the user that a measure of replenishing the recording sheet into the first tray 6 must be taken. When the multifunction device 1 confirms that the user reset the sheet feed error by taking a measure of replenishing the recording sheet into the first tray 6, the process returns to S23 of FIG. 9 and performs printing processing of this print image data again.

As shown in FIG. 10, if the sheet size selection result history information is the same as the requested sheet size 242b of the page information (S48: YES), it is judged that the user does not desire to change the sheet size selected in the last printing processing. Thus, the process goes to S49 and judges whether the tray selection result history information of the tray selection result history information storage unit 244 is Tray 1 (first tray 6) or Tray 2 (second tray 60). In the multifunction device 1, the first tray 6 is set so as to be given priority over the second tray 60. However, it is expected that after starting printing based on one image data, the user will designate the same tray in many cases. Accordingly, it is reasonable that the tray selected in the last printing processing is selected by priority.

As shown in FIG. 10, if the tray selection result history information is Tray 1 (S49: Tray 1), the process goes to S30 of FIG. 9 and indicates a sheet absence error of the first tray 6 on at least either one of the display part 133 of the multifunction device 1 or the display 260 of the client PC 201 (see FIG. 11). It is presumed that in the first tray 6 selected immediately before this printing processing, a recording sheet of a sheet size selected immediately before this printing processing are accommodated. However, the first tray 6 accommodates no designated recording sheet (see S39: NO, S46: NO of FIG. 10). Therefore, the multifunction device 1 indicates a sheet absence error of the first tray 6 on at least either one of the display part 133 of the multifunction device 1 or the display 260 of the client PC 201 to inform the user that a recording sheet of a sheet size the same as that of the recording sheet that had been accommodated in the first tray 6 must be replenished into the first tray 6. When the multifunction device 1 confirms that the user reset the sheet feed error by replenishing the recording sheet into the first tray 6, the process returns to S23 of FIG. 9 and performs printing processing of this print image data again.

As shown in FIG. 10, if it is judged that the tray selection result history information is Tray 2 (S49: Tray 2), the process goes to S37 of FIG. 9 and indicates a sheet absence error of the second tray 60 on at least either one of the display part 133 of the multifunction device 1 or the display 260 of the client PC 201 (see FIG. 11). It is presumed that in the second tray 60 selected immediately before this printing processing, the recording sheet of a sheet size selected immediately before this printing processing are accommodates. However, the second tray 60 selected immediately before this printing accommodates no recording sheet (see S46: NO of FIG. 10). Therefore, the multifunction device 1 indicates a sheet absence error on at least either one of the display part 133 of the malfunction printer 1 or the display 260 of the client PC 201 to inform the user that the recording sheet of the same sheet size as that of the recording sheet that had been accommodated in the second tray 60 must be replenished into the second tray 60. When the multifunction device 1 confirms that the user reset the sheet feed error by replenishing the recording sheet into the second tray 60, the process returns to S23 of FIG. 9 and performs the printing processing of this print image data again.

On the other hand, as shown in FIG. 10, if the second tray 60 accommodates the recording sheet (S46: YES), the process goes to S50 and judges whether the sheet size of Tray 2 (second tray 60) is the same as the requested sheet size 242b of the page information. If the sheet size of the second tray 60 is the same as the requested sheet size 242b of the page information (S50:YES), the process goes to S34 of FIG. 9 and performs printing by picking up the recording sheet from the second tray 60 (see FIG. 11). Since the S34 and subsequent processing of FIG. 9 were described above, description of these is omitted here.

On the other hand, if the sheet size of the second tray 60 is not the same as the requested sheet size 242b of the page information (S50: NO), the process goes to S51 and judges whether the user printing start mark 242a has been set in the page information. If the user printing start mark 242a has been set in the page information (S51: YES), it is judged that the process is before starting printing based on one image data. Thus, the process goes to S36 of FIG. 9 and indicates a sheet size error of the second tray 60 on at least either one of the display part 133 of the multifunction device 1 or the display 260 of the client PC 201 (see FIG. 11). If a recording sheet of a sheet size not the same as the requested sheet size 242b is accommodated in the second tray 60 in a state that the first tray 6 accommodates no recording sheet, it is unknown whether the user considers that printing must be performed on the recording sheet of the designated sheet size or permits printing on the recording sheet of a sheet size different from the designated sheet size picked up from the second tray 60. Therefore, the multifunction device 1 indicates the sheet size error of the second tray 60 on at least either one of the display part 133 of the multifunction device 1 or the display 260 of the client PC 201 to inform the user that the recording sheet of the sheet size that the user desires is not accommodated in the second tray 60. When the multifunction device 1 confirms that the user reset the sheet feed error by taking a measure of replenishing the recording sheet of the same sheet size as that of the sheet accommodated in the second tray 60 or inputting an instruction for continuing printing by picking up the recording sheet of a sheet size different from the designated sheet size from the second tray 60, the process returns to S23 of FIG. 9 and performs printing processing of this print image data again.

On the other hand, as shown in FIG. 10, if the user printing start mark 242a has not been set in the page information (S51: NO), the process goes to S52 and judges whether the sheet size selection result history information of the sheet size selection result history information storage unit 245 is the same as the requested sheet size 242b of the page information. If the sheet size selection result history information is not the same as the requested sheet size 242b of the page information (S52: NO), the process goes to S36 of FIG. 9 and indicates a sheet size error of the second tray 60 on at least either one of the display part 133 of the multifunction device 1 or the display 260 of the client PC 201 (see FIG. 11). In a state that the first tray 6 accommodates no recording sheet and the second tray 60 accommodates the recording sheet (see S39: NO, S46: YES of FIG. 10), the sheet size difference from the sheet size selection result history information (see S52: NO of FIG. 10) means that the user desires to change the sheet size in the middle of printing. In this case, it is expected that the user will take the recording sheet out of the second tray 60 and put the recording sheet of another sheet size into the second tray 60. Therefore, the multifunction device 1 selects the second tray 60 accommodating the recording sheet by priority, and indicates a sheet size error of the second tray 60 on at least either one of the display part 133 of the multifunction device 1 or the display 260 of the client PC 201. When the multifunction device 1 confirms that the user reset the sheet feed error by taking the recording sheet out of the second tray 60 and replacing these with the recording sheet of a sheet size that the user desires, the process returns to S23 of FIG. 9 and performs printing processing of this print image data again.

On the other hand, as shown in FIG. 10, if the sheet size selection result history information is the same as the requested sheet size 242b of the page information (S52: YES), it is judged that the user does not desire to change the sheet size from the size of the last printing processing. Thus, the process goes to S53 and judges whether the tray selection result history information of the tray selection result history information storage unit 244 is Tray 1 (first tray 6) or Tray 2 (second tray 60). In the multifunction device 1, priority of the first tray 6 over the second tray 60 is set. However, after starting printing based on one image data, it is expected that the tray to be selected will be the same as that of the last printing processing in many cases. Accordingly, it is reasonable that the tray selected in the last printing processing is selected by priority.

As shown in FIG. 10, if the tray selection result history information is Tray 1 (S53: Tray 1), the process goes to S30 of FIG. 9 and indicates a sheet absence error of the first tray 6 on at least either one of the display part 133 of the multifunction device 1 or the display 260 of the client PC 201 (see FIG. 11). It is presumed that in the first tray 6 selected immediately before this printing processing, the recording sheet of a sheet size selected immediately before this printing processing are accommodated. However, at S53, it is judged that the first tray 6 accommodates no recording sheet (see S39: NO of FIG. 10). Therefore, the multifunction device 1 indicates a sheet absence error of the first tray 6 on at least either one of the display part 133 of the multifunction device 1 or the display 260 of the client PC 201 to inform the user that the recording sheet of the same sheet size as that of the recording sheet that had been accommodated in the first tray 6 must be replenished into the first tray 6. When the multifunction device 1 confirms that the user reset the sheet feed error by replenishing the recording sheet into the first tray 6, the process returns to S23 of FIG. 9 and performs processing of this print image data again.

As shown in FIG. 10, if the tray selection result history information is Tray 2, the process goes to S36 of FIG. 9 and indicates a sheet size error of the second tray 6 on at least either one of the display part 133 of the multifunction device 1 or the display 260 of the client PC 201 (see FIG. 11). It is presumed that in the second tray 60 selected immediately before this printing processing, the recording sheets of a sheet size selected immediately before this printing processing are accommodated. However, at S53 of FIG. 10, the first tray 6 accommodates no recording sheet. Even when the second tray 60 accommodates the recording sheet, the sheet size of the recording sheet is judged as different from the sheet size that the user desires (see S39: NO, S46: YES, S50: NO of FIG. 10). Therefore, the multifunction device 1 indicates a sheet size error of the second tray 60 on at least either one of the display 260 of the client PC 20 or the display 260 of the client PC 201 to inform the user that the recording sheet in the second tray 60 must be replaced with the recording sheet of a sheet size that the user desires. When the multifunction device 1 confirms that the user reset the sheet feed error by replacing the recording sheet in the second tray 60 with the recording sheet of the desired sheet size, the process returns to S23 of FIG. 9 and performs printing processing of this print image data again.

Summarizing the operations of the multifunction device 1 in the case of automatic designation, if the first tray 6 or second tray 60 accommodates the recording sheet of a designated sheet size, the multifunction device 1 performs printing by selecting the tray accommodating the recording sheet of the designated sheet size and picking up the recording sheet.

If both of the first tray 6 and the second tray 60 accommodate the recording sheet and the sizes of the recording sheet in these trays are not the designated sheet size, the multifunction device 1 indicates a sheet size error of the first tray 6 that is given priority.

If neither the first tray 6 nor the second tray 60 accommodates the recording sheet, the multifunction device 1 selects a tray that is given priority in principle (first tray 6 in this aspect) and indicates a sheet absence error of the first tray 6. However, in this case, if the process is in the middle of printing and the tray selected in the last printing processing is not the priority tray (the second tray 60 in this aspect), a sheet absence error of the second tray 60 is indicated.

If either the first tray 6 or the second tray 60 accommodates the recording sheet and the size of the recording sheet is not the designated sheet size, if the process is before starting printing based on one image data, the multifunction device 1 indicates a sheet size error of the tray accommodating the recording sheet.

If either the first tray 6 or the second tray 60 accommodates the recording sheet and the size of the recording sheet is not the designated sheet size, if the process is after starting printing based on one image data, the multifunction device 1 indicates a sheet size error of the tray accommodating the recording sheet in principle. However, in the case where either the first tray 6 or the second tray 60 accommodates the recording sheet and the size of the recording sheet is not the designated sheet size, even when the process is after starting printing based on one image data, if the sheet size is the same as that of the last printing processing and the tray selected in the last printing processing is the tray that accommodates no recording sheet, the multifunction device 1 indicates a sheet absence error of the tray that accommodates no recording sheet.

The multifunction device 1 configured as described above indicates sheet size error as first output when a failure occurs that no recording sheet matching a sheet size requested for printing of image data is in the first and second trays 6 and 60 in a state that at least either one of the first tray 6 or second tray 60 accommodates the recording sheet and this failure occurs before printing (see S39: YES, S40: NO, S41: NO, S43: YES of FIG. 10, S29 of FIG. 9, and S39: NO, S46: YES, S50: NO, and S51: YES, and S36 of FIG. 9). On the other hand, if the failure occurs after printing (S39: YES, S40: NO, S41; NO, S43: NO, S44: YES, S45: Tray 2 of FIG. 10, S37 of FIG. 9, S39: NO, S46: YES, S50: NO, S51: NO, S52: YES, S53: Tray 1 of FIG. 9, and S30 of FIG. 9), the multifunction device 1 indicates sheet absence error as second output. Therefore, when the recording sheet matching a sheet size requested for printing has run out in the first and second trays 6 and 60, the multifunction device 1 in this aspect outputs different content depending on the printing status. Thus, a user is accurately urged to take a measure for a sheet feed error, and usability is improved.

The usability of the multifunction device 1 will be described in more detail based on a detailed example.

For example, if a size of the recording sheet to be filed in a file book that a plurality of users use is predetermined to be A4 size, a user designates A4 size recording sheet and inputs image data into the multifunction device 1 upon setting the tray selection to automatic setting. Herein, it is assumed that, in the multifunction device 1, the sheet size of the first tray 6 is A4 size, and the sheet size of the second tray 60 is Letter size.

In this case, for example, it is assumed that a failure has occurred that the second tray 60 accommodates the recording sheet and the first tray 6 accommodates no recording sheet, and the sheet size of the second tray 60 is Letter size. If this sheet feed error occurs before starting printing, instead of immediately performing printing by using the recording sheet of Letter size accommodates in the second tray 60 as disclosed in the related art, the multifunction device 1 temporarily stops the printing and indicates a sheet size error of the second tray 60 on the display part 133 or the display 260. The user can recognize that the sheet size of the recording sheet to be accommodated in the second tray 60 is not A4 size by looking at the indication content without taking the second tray 60 out of the casing 3 and confirming the sheet size. In this case, the user can take a measure of continuing printing on the recording sheet of Letter size from the second tray 6 and a measure of replacing the recording sheet in the second tray 60 with A4 size recording sheet and then performing printing. However, in the above-described example, the size of the recording sheet to be filed in the file book is predetermined to be A4 size. Thus, it is expected that the user will take the latter measure. When the multifunction device 1 confirms that the sheet size error has been reset by sheet replacement in the second tray 60, it restarts printing.

On the other hand, during printing by picking up A4 size recording sheet from the first tray 6 by the user, if a sheet feed error has occurred that the second tray 60 accommodates the recording sheet but the recording sheet in the first tray 6 has run out, and if the sheet size of the second tray 60 is Letter size, instead of continuing printing by selecting the second tray 60 accommodating the Letter size recording sheet most approximate to the A4 size without the user's permission as in the case of the related art, the multifunction device 1 temporarily stops printing and indicates a sheet absence error of the first tray 6 on the display part 133 or the display 260. The user can recognize that the A4 size recording sheet accommodated in the first tray 6 has run out by looking at the indication contents without taking the first tray 6 out of the casing 3 and confirming the presence of the sheet. In this case, it is expected that the user will take a measure of replenishing A4 size recording sheet into the first tray 6 and then performing printing. When the multifunction device 1 confirms that the sheet size error has been reset due to sheet replenishment into the first tray 6, it restarts printing.

Thus, for example, in a state that the second tray 60 accommodates the recording sheet and the first tray 6 accommodates no recording sheet, if a sheet feed error occurs that the sheet size of the second tray 60 is Letter size, instead of continuing printing by changing the A4 size that the user designated into Letter size of the second tray 60 without user's permission, the multifunction device 1 switches and indicates the sheet size error of the second tray 6 and sheet absence error of the first tray 6 depending on whether the error occurs before or after printing. Therefore, the user can properly select a measure according to the indication content and does not have to waste the printing work or repeat the same printing operations.

According to the multifunction device 1 in this aspect, the user printing start mark 242a is added to the page information based on the receiving command user start information included in the image data, and depending on the presence of the user printing start mark 242a, it is judged whether the image forming is started based on one image data (see S5: YES and S6 of FIG. 8 and S43, S51 of FIG. 10). Thus, when printing one image data on the recording sheet, the indication of sheet size error and the indication of sheet absence error can be accurately switched.

The image data can be individually distinguished based on user start information. Thus, for example, a plurality of image data that a same user serially inputted can be properly processed.

Herein, before starting printing, in a state that either the first tray 6 or second tray 60 accommodates the recording sheet, when a sheet feed error occurs that recording sheet of a sheet size requested for printing of image data is not accommodated, it is expected that the user will take a measure of replacing the recording sheet with the recording sheet of the desired sheet size or a measure of continuing printing without concern for the sheet size difference. Therefore, when it is before starting printing, the multifunction device 1 indicates Tray 1 sheet size error indicating that the sheet size of the recording sheet to be accommodated in the selected tray is not the same as the sheet size requested for printing of image data on the display part 133. On the other hand, after starting printing, in a state that either the first or second tray 6 or 60 accommodates the recording sheet, when a sheet feed error occurs that no recording sheet of the sheet size requested for printing of image data is accommodated, it is generally presumed that the tray and sheet size are rarely changed in one job. Thus, it is expected that a user will take a measure of replenishing the recording sheet of the same sheet size into the tray in which the recording sheet has run out. Therefore, when it is after starting printing, the multifunction device 1 indicates an instruction on the display part 133 to inform that no recording sheet exists in the selected tray. Thus, according to the multifunction device 1 in this aspect, even when the content of the sheet feed errors are the same, the sheet size error and the sheet absence error are distinguished depending on before or after printing and a user can be accurately urged to take a measure for the sheet feed error.

The multifunction device 1 in this aspect has limit switches 9 and 90 which detect sheet sizes of the recording sheets accommodated in the first and second trays 6 and 60, respectively. Thus, the sheet sizes of the recording sheet accommodated in the first and second trays 6 and 60 can be automatically recognized. Accordingly, effort of the user for setting the sheet size can be saved.

According to an image forming system 200 in this aspect, in a multifunction device 1, in a state that at least either the first or second tray 6 or 60 accommodates the recording sheet, when a failure occurs in that the recording sheet of a size matching a sheet size requested for printing of image data is accommodated in neither the first tray 6 nor the second tray 60, if this failure occurs before starting printing, display information including sheet size error as first output is transmitted to the client PC 201A via the network 202 and the sheet size error is indicated on the display 260 of the client PC 201A. On the other hand, if the failure occurs after starting printing, display information including sheet absence error as second output is transmitted to the client PC 201A via the network 202 and the sheet absence error is indicated on the display 260 of the client PC 201A. Therefore, according to the image forming system 200 in this aspect, when the recording sheet of a size matching the sheet size requested for printing has run out in the first and second trays 6 and 60, display information with error indication content different depending on the printing status is transmitted from the multifunction device 1 to the client PC 201A, and a warning that informs that a sheet size error or sheet absence error occurs in a specific tray is indicated on the display 260 of the client PC 201. Accordingly, a user remote from the multifunction device 1 can be informed of the contents of the sheet feed error and accurately urged to take a measure for the sheet feed error. Thus, usability is improved.

In addition to the above-described aspect of the present invention, the invention may be variously applicable.

(1) For example, in the above-described aspect, the sheet sizes of the recording sheets accommodated in the first and second trays 6 and 60 are automatically recognized by using the limit switches 9 and 90. However, the sheet sizes of the first and second trays 6 and 60 may be manually set from the operating part 121 of the multifunction device 1.

(2) For example, in the above-described aspect, the sheet size error and the sheet absence error are visually outputted via the display part 133. However, the errors may be visually outputted by using the indication lamp 132 or may be auditorily outputted as a buzzer sound or warning message from the speaker 134.

(3) For example, in the above-described aspect, the image data are distinguished based on the user start information included in receiving commands. However, the image data may be distinguished based on user end information which is provided at the end of the receiving commands. Further, the image data may also be distinguished based on the user start information and the user end information.

(4) For example, in the above-described aspect, in order to secure a storage capacity, when adding a new setting to the tray selection result history or sheet size selection result history, the last tray selection result history information or sheet size selection result history information is erased from the tray selection result history information storage unit 245 or the sheet size selection result history information storage unit 246. However, they may be accumulated and stored to a fixed amount. In the above-described aspect, the tray selection result history information or the sheet size selection result history information is rewritten each time of printing regardless of whether the tray selection result or sheet size result is different from the last one. However, it is also possible that the tray selection result history information or the sheet size history information is rewritten only when the tray selection result or the sheet size selection result is different from the last one, whereas when the tray selection result or sheet size selection result is not changed from the last one, the tray selection result history information or sheet size selection result history information is not rewritten.

(5) In the above-described aspect, the multifunction device 1 is used as the image forming apparatus. However, a printer, a copying machine or a facsimile may also be used as the image forming apparatus.

What is claimed is:

1. An image forming apparatus comprising:
a plurality of sheet feed units, the respective sheet feed units corresponding to different sizes of recording sheet;
an image forming unit which forms an image on the recording sheets based on image data;
sheet presence detecting units each detecting presence of the recording sheets in the respective sheet feed units;
a sheet size judging unit which judges whether the sizes of the recording sheets in the respective sheet feed units match a requested sheet size for image forming of the image data;
a first output unit which performs a first output prior to the image forming by the image forming unit when the sheet size judging unit judges that a size of a recording sheet judged by the sheet presence detecting units to be present in at least one of the sheet feed units does not match a recording sheet of the requested sheet size; and
a second output unit which performs second a output after the image forming is started when the sheet size judging unit judges that a size of a recording sheet judged by the sheet presence detecting units to be present in at least one of the sheet feed units does not match a recording sheet of the requested sheet size.

2. The image forming apparatus according to claim 1, further comprising:
an image forming period judging unit which judges whether the image forming is started based on the one image data according to the presence of image forming start information corresponding to the image data.

3. The image forming apparatus according to claim 1, further comprising:
a display unit which displays information,
wherein the first output unit displays on the display unit an instruction for informing that the at least one of the sheet feed units does not accommodate a recording sheet of the requested sheet size, and
wherein the second output unit displays on the display unit an instruction for informing that no recording sheet exists in the at least one of the sheet feed units.

4. The image forming apparatus according to claim 1, further comprising a sheet size detecting unit which detects sheet sizes of the recording sheets accommodated in the plurality of sheet feed units.

5. An image forming system comprising:
an image forming apparatus; and
an external device which communicates with the image forming apparatus,
wherein the image forming apparatus includes:
a plurality of sheet feed units, the respective sheet feed units corresponding to different sizes of recording sheet;
an image forming unit which forms an image on the recording sheets based on image data;
a receiving unit which receives the image data from the external device;
sheet presence detecting units each detecting presence of the recording sheets in the respective sheet feed units;
a sheet size judging unit which judges whether the sheet sizes of the recording sheets in the respective sheet feed unit match a requested sheet size for image forming of the image data;
a first output unit which performs a first output prior to the image forming by the image forming unit when the sheet size judging unit judges that a size of a recording sheet judged by the sheet presence detecting units to be present in at least one of the sheet feed units does not match a recording sheet of the requested sheet size; and
a second output unit which performs a second output after the image forming is started when the sheet size judging unit judges that a size of a recording sheet judged by the sheet presence detecting units to be present in at least one of the sheet feed units does not match a recording sheet of the requested sheet size, and wherein the external device includes:
a display unit which performs displaying according to the first output or the second output received from the image forming apparatus.
